(19) United States
(12) Patent Application Publication
(10) Pub. No.: US 2009/0038565 A1
(43) Pub. Date: Feb. 12, 2009

(54) Continuous Otto piston elliptical engine

(76) Inventor: Mohammed Ibraheem Asender, Amman (JO)

Correspondence Address: ABELMAN, FRAYNE & SCHWAB, 666 THIRD AVENUE, 10TH FLOOR, NEW YORK, NY, 10017, US

(21) Appl. No.: 11/891,662

(22) Filed: Aug. 9, 2007

(51) Int. Cl. F02B 75/22; F02F 1/18; F01M 9/00; F02B 75/32

(52) U.S. Cl. 123/55.5; 123/197.1; 123/193.2; 123/196 R

(57) ABSTRACT

A continuous Otto piston elliptical engine including cylinder and ellipse, where the cylinder includes:
i. an X shape layout of the common Otto cycle pistons in a single block,
ii. a coolant inlet port and a coolant outlet port (Part Nos. 42 and 43, FIG. 3),
iii. where lubrication of pistons is done by the lubricating liquid splashed by the connecting arms, guide arm and the up down movement of the pistons themselves (Part No. 29, FIG. 2),
iv. conventional spark plugs are placed in the cylinder (Part No. 36, FIG. 2),
v. there is a contact between the guiding arm and the connecting rod which make an arc trace which force the ellipse to rotate (Part No. 29, FIGS. 2), and
vi. the holes the sparkplug cables pass through (Part No. 32, FIG. 2).

### I. BACKGROUND

A. Field of the Invention

The present invention relates generally to rotary devices, and specifically to rotary engines and pressure and vacuum pumps and compressors and any form that mechanical power is harvested from combusting fossil fuel.

B. Prior Art

A conventional four-stroke combustion piston in the common engine delivers power every second revolution of the crank shaft. As most engines have at least 120-150 moving parts that need to be separated by oil to operate efficiently, the engine is loaded with frictional loss, heat loss and inertia every revolution, and the power is delivered every second revolution which reduces efficiency of the engine as useful mechanical available shaft power per revolution. The conventional two-stroke engine can produce one power stroke per revolution, but is less power efficient than the four-stroke engine. The rotary ‘Wankel” engine has three power strokes per revolution and is lighter and has less moving parts compared to the conventional piston engine but is much more difficult to maintain, produces harmful fumes into the atmosphere due to the incomplete combustion, poor in harvesting the power of the combusted fuel due to the shape of the combustion chamber, problems in seal design. The current invention is more like the “Quasiturbine” engine which has four power strokes per revolution and delivers much higher power than conventional layout piston engine, but as the same is difficult in manufacture, less availability of parts, lack of familiarity in maintenance power lost in rotating the big block of the engine and the indirect combustion force direction in the movement of the engine's moving part. In general all of the rotary engines so far have some or all of the following drawbacks:

(a) complexity,

(b) many moving parts which consume power as heat and inertia,

(c) difficulty in making the seals,

(d) the longitude shape of the power chamber which is poor in harvesting power from the expanding volume resulting from combustion,

(e) the power generated in the expanding volume of the gases in the power chamber is not directed into single direction of movement which can be converted into useful mechanical power,

(f) not meeting the current emission fume standards in most countries,

(g) impracticality in lubricating some parts that have relative movement with each other,

(h) heat generated is difficult to cool (cooling problems),

(i) new unstudied combustion methods that need a lot of time and research to be practically used and maintained by general public, and

(j) the tedious efforts required in synchronizing many parts of the engine together while running and during assembly.

### III. OBJECTS AND SUMMARY OF THE NEW INVENTION

The object of this invention was to design a new engine concept with an engine that uses the normal four-stroke Otto cycle piston engine method in converting the chemical energy from the combusting fuel by volume expansion into useful mechanical power. This has been widely used, fully studied, and can be considered to be an established art, which would make the production, usage and maintenance of this engine just a simple modification of the shape and layout of conventional engine and its pistons. The way of the layout which is central X shape layout of pistons being back to back with the movement expanding to the sides of a cube in close proximity reduces the bulk of the engine block needed to house them which in turn makes cooling easer and does not keep a lot of heat entrapped in big metal block.

### IV. BRIEF DESCRIPTION OF THE DRAWINGS

FIG. 1 is a top plan view in section of the new engine,

FIG. 2 is an exploded bottom perspective view of the new engine,

FIG. 3 is an exploded top perspective view of the new engine,

FIG. 4 is a top perspective view of the new engine with the top cover removed, and

FIG. 5 is a bottom perspective view of the new engine with the bottom cover removed.

### V. DETAILED DESCRIPTION OF THE PREFERRED EMBODIMENTS

For convenience and clarity in describing these embodiments, similar elements or components appearing in different figures will have the same reference numbers.

The main part is the elliptical shape of the rim which besides redirecting the vertical movement of the pistons into rotational torque also keeps all parts of the engine in synchronization with each other. The internal part of the engine is stationary and the rotating part is the rim which also acts as a camshaft of the engine. Without the use of timing belt or gearing, there is no need for an oil pump as the moving parts splash the oil to the parts that need lubrication in the block.

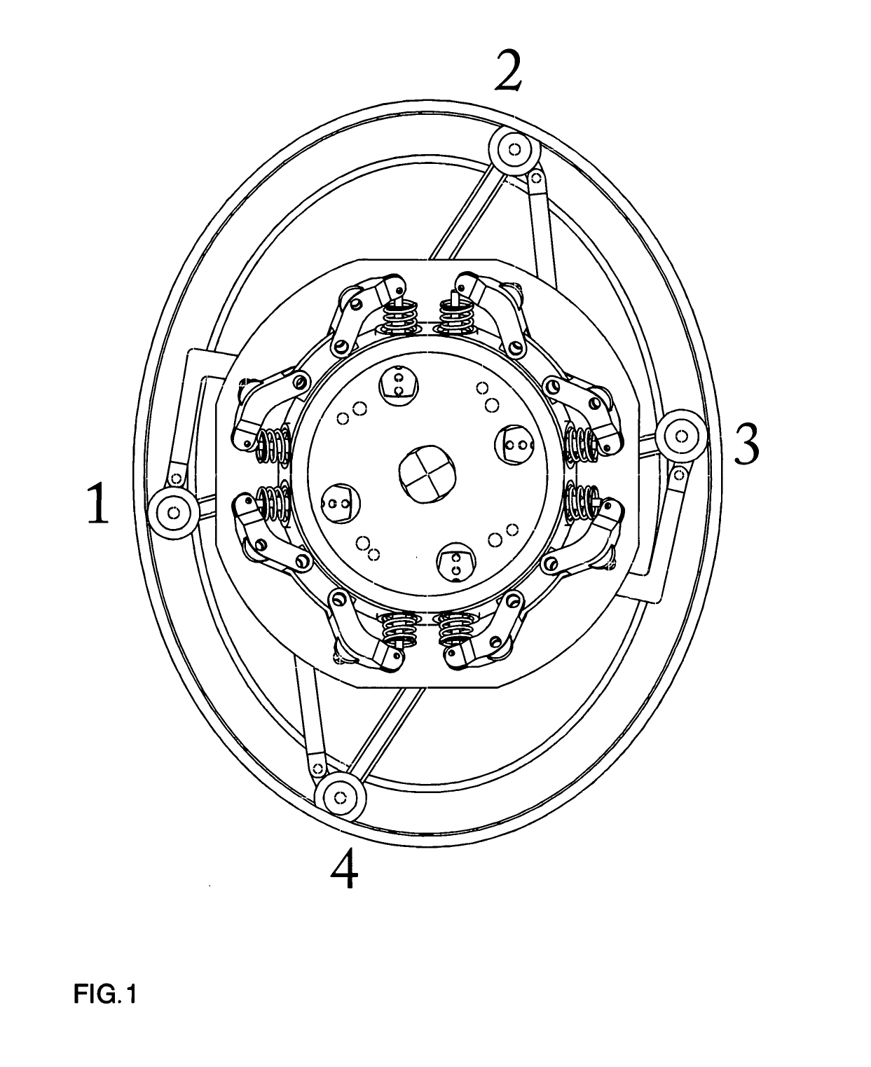

In the X-shape layout of the common Otto cycle the pistons situated back to back (FIG. 1) such that the force of the expanding volume of the combusting fuel is directed outwards, the connecting rods (9) which has push bearing on top (12) pushes the ellipse outwards in clockwise direction, and due to the guiding arm (10) retains in contact with the ellipse in an arc trace (locus) in order to extract all the power produced from the piston and convert it into rotation of the rim.

The connecting rod and the guide arm in conjunction with the ellipse converts the up down movement of the pistons into rotational torque, the rim acting as a crankshaft. Any and all of the pistons complete the Otto full cycle in one revolution of the rim. Piston 1, FIG. 1 is in compression stroke. Piston 2, FIG. 1 is in force stroke. Piston 3, FIG. 1 is in induction stroke. Piston 4, and FIG. 1 is in exhaust stroke.

The power delivered as torque to the rim is four power strokes in each rotation, push bearings in contact with the inner surface of the ellipse keeps contact with the rim in the power stroke of the piston while minimizing the friction. Pull bearings (13) on both sides of the connecting rod keep contact with the inner ellipse guide (6) in order to pull up the piston in the induction stroke of the piston. Position 1,3 are compression and exhaust strokes successively and are achieved by the ellipse rim pushing down the pistons by push bearings and connecting rods.

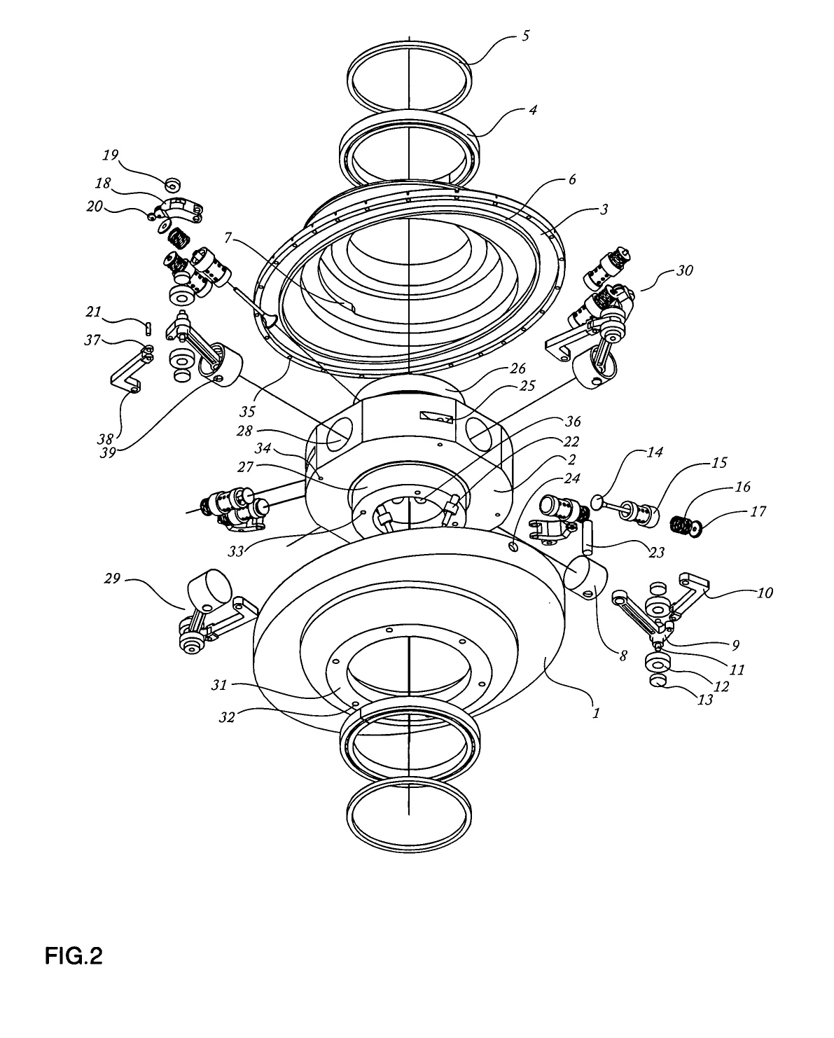

In FIG. 2, the valves are kept in synchronization with the required Otto cycle by bearing (19) and (19-) in collaboration with the tooth (7) for bearing (19) to open the inlet valve and tooth (7-) for bearing (19-) to open the exhaust valve. The closing of the valves is done by springs (16). The tooth (7) is made in a manner FIG. 2 with consideration of radius of curvature of bearing (19) to minimize panging and the end side of the tooth to reduce noise and allow the bearings and valves to open and close in smooth operation, unlike the valves using a cam shaft in the conventional engine which does not give the valves long time to stay open, rather opens slowly and when it reaches peak position opened it starts closing again. In the method used in this invention the valves stay fully open for nearly 70% and more in the peak position of the time of induction and exhaust cycles, which in turn reduces the effort on the pistons trying to fill the cylinder or exhaust fumes through a smaller opening while it reduces the opening, thus giving the affect of Otto cycle with easier valve control without the use of camshaft and timing built.

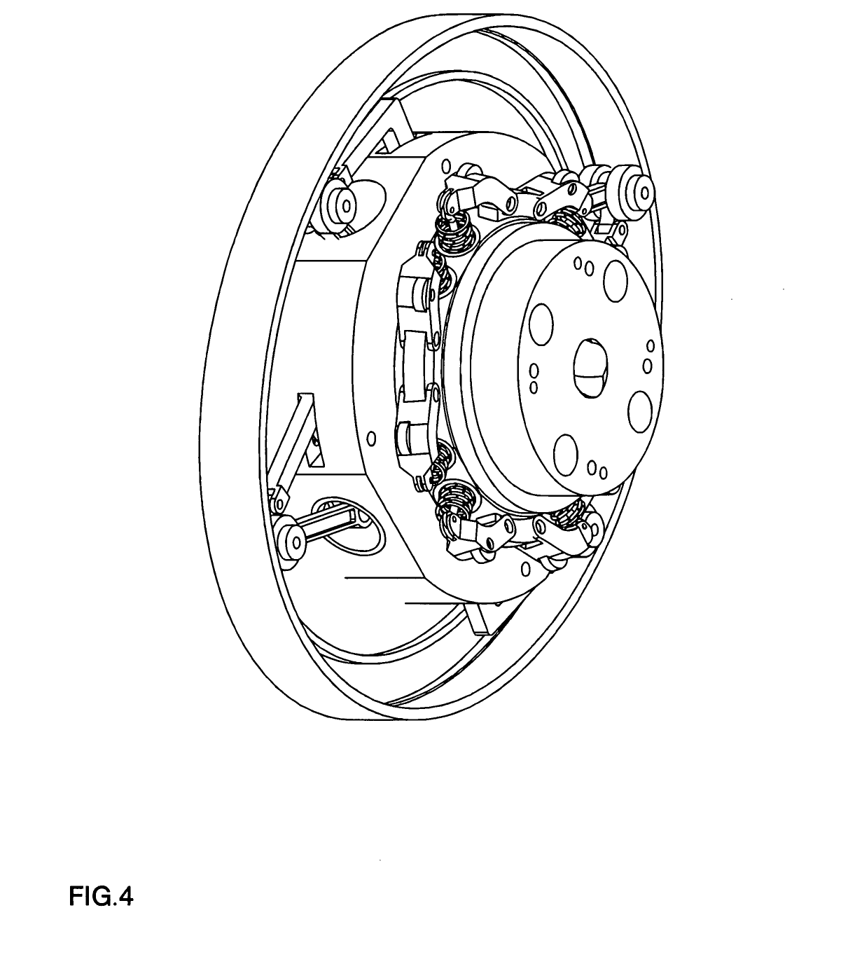

The displacement between the teeth of the inlet valve and exhaust valve controls is equal to the physical distance between bearing (19) and (19-) taken into consideration the valve timing required to obtain maximum efficiency of the Otto cycle, FIG. 4 graph of comparing a conventional valve and the valve in this invention, the area under both curves indicate the total opening achieved in one induction or exhaust cycles, clearly the control in this invention achieves better than two conventional camshaft valves.

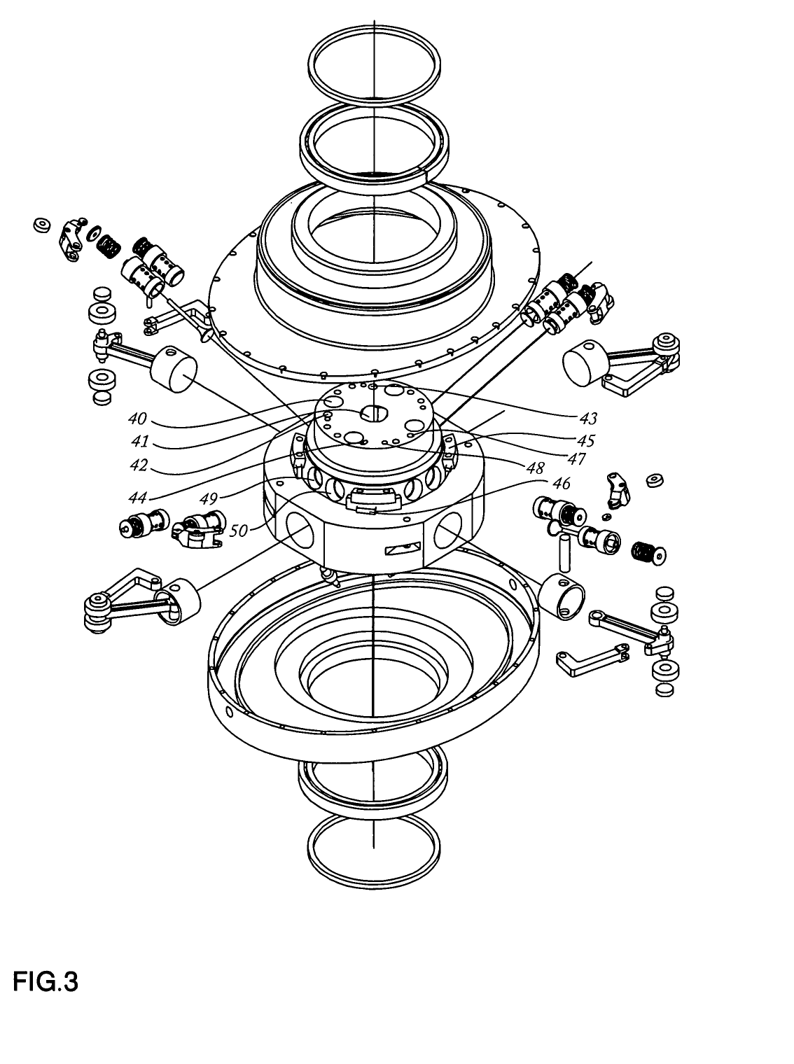

The mixture is passed to the pistons via passages (40) FIG. 3 depending on the valve opened; the exhaust fumes are discharged by the inwards going piston with its valve open through passage (41).

The conventional spark plugs (22) are placed as FIG. 4 with wiring passing all the way through holes (33).

The sleeves of the pistons are flanged in order to increase the surface area and result in better conduction of heat to the water based heat transferring liquid conversing the heat to the exterior through hole (43) as input and (42) in FIG. 3 as output. Lubrication of the inner surface of the ellipse and the push bearings (12) is maintained by the centrifugal force acting on the lubrication to stay on the surface. Lubrication of pistons is done by the lubricating liquid splashed by the connecting arm, guide arm and the up down movement of the pistons themselves.

The lubricant enters the ellipse through hole (24) and exit thought the hole from the other side.

While the invention has been described in conjunction with several embodiments, it is to be understood that many alternatives, modifications, and variations will be apparent to those skilled in the art in light of the foregoing description. Accordingly, this invention is intended to embrace all such alternatives, modifications, and variations which fall within the spirit and scope of the appended claims.

### ENGINE PARTS

1—Rear ellipse
2—Cylinder
3—Front ellipse
4—Bearing—2 pieces
5—Oil ring—2 pieces
6—Piston induction
7—Camshaft
8—Piston—4 pieces
9—Connecting arm—4 piece
10—Connecting arm guide—4 pieces
11—Connecting arm bearings pin—4 pieces
12—Push bearings—8 pieces
13—Pull bearings—8 pieces
14—Valve—8 pieces
15—Valve casing—8 pieces
16—Valve spring—8 pieces
17—Valve spring lock washer—8 pieces
18—Rocker arm
19—Rocker arm bearing
20—Valve adjuster—8 pieces
21—Guide arm Pin—4 pieces
22—Spark plug—4 pieces
23—Piston pin—4 pieces
24—Oil hole—quantity 2
25—Guide groove—quantity 4
26—Front bearing set
27—Rear bearing set
28—Liner—4 pieces
29—Piston set
30—Valve set
31—Flywheel attache
32—Bolt hole—quantity 6
33—Spark plug cable hole—quantity 4
34—Guide arm pin—quantity 4
35—Ellipse jointer—24
36—Spark plug seat—4
37—Guide and connecting rod pin—4
38—Guide and cylinder pin—4
39—Piston pin—4
40—Mixture Intake—4
41—Exhaust
42—Coolant outlet
43—Coolant inlet
44—Pressure relief
45—Rocker fixture—4
46—Pressure relief
47—Spark plug cable—4
48—Fixing arm—12
49—Exhaust valve—4
50—Intake valve—4

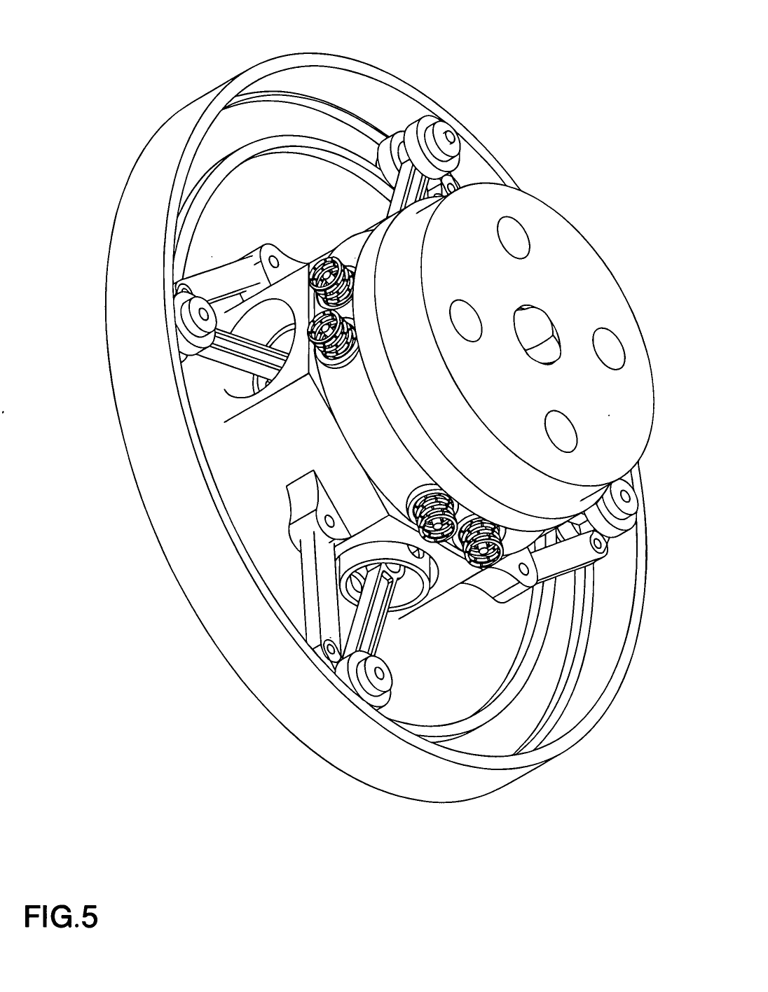

1. A continuous Otto cycle piston engine comprising a stationary cylinder an elliptical rotor,
i) an X shape layout of the Otto cycle pistons in a single block.
ii) a coolant inlet port, a coolant outlet port (Parts No. 42 & 43, FIG. 3),
iii) a way of installing the valve in the cylinder (Parts No. 49 & 50, FIG. 3) including a valve case (Part No. 15, FIG. 2),
iv) lubrication of pistons is done by the lubricating liquid splashed by the connecting arm, guide arm and the up down movement of the pistons themselves (Part No. 29, FIG. 2),
v) conventional spark plugs are placed in the cylinder (Part No. 36, FIG. 2),
vi) a contact between the guiding arm and the connecting rod which make an arc trace which force the elliptical rotor to rotate (Part No. 29, FIG. 2),
vii) the holes the sparkplug cables pass through (Part No. 32, FIG. 2),
ix) a pressure relief passage (Part No. 46 FIG. 3),
x) A groove in the cylinder connects the guiding arm (Part No. 25, FIG. 2), and
xi) the groove can be replaced by an external part of the cylinder (FIG. 5).

2. (canceled)

3. (canceled)

4. An engine of claim 1 wherein said elliptical rotor (Part Nos. 1 & 3, FIG. 2) comprises:
i) an inner elliptical rotor guide which pulls up and push down the piston in the induction stroke (Part No. 6, FIG. 2),
ii) a cam tooth in the elliptical rotor which synchronize the opening and closing of the valves (Part No. 7, FIG. 2), and
iii) the oil enters the elliptical rotor from hole (Part No. 24, FIG. 2) and exit from the other side of the elliptical rotor.

5. A continuous Otto cycle piston engine comprising:
a. a stationary cylinder block,
b. an elliptical-rotor, and
c. four pistons arranged in an X-shape and movable in said cylinder block,
d. coolant inlet and outlet ports in said cylinder block, and
e. four spark plugs securable in said cylinder block adjacent said four pistons respectively,
wherein lubrication of said pistons is done by lubricating liquid splashed by a connecting arm, guide arm and the up-down movement of said pistons themselves, and
wherein there is contact between said guiding arm and said connecting rod which make an arc trace which forces said elliptical-rotor to rotate.

6. An engine according to claim 5 wherein said cylinder block further comprises holes to receive spark plug cables, and a pressure relief passage for each of said pistons.

7. An engine according to claim 5 further comprising a radially extending groove in said cylinder or receiving said guiding arm.

8. An engine according to claim 5 wherein said cylinder further comprises an inner elliptical guide which pulls up and pushes down each of said pistons in its induction stroke, and a cam shaft in said elliptical guide which synchronizes the opening and closing of said valves.

9. An engine according to claim 8 wherein said cylinder further comprises an oil hole through which oil enters and flows and exits via another oil hole on the other side of said elliptical rotor.
